(19) United States
(12) Patent Application Publication
(10) Pub. No.: US 2026/0034967 A1
(43) Pub. Date: Feb. 5, 2026

(54) WINDSHIELD WIPER CONNECTOR, WINDSHIELD WIPER, VEHICLE, AND PROCESS FOR MANUFACTURING A CONNECTOR

(71) Applicant: VALEO SYSTEMES D'ESSUYAGE, La Verriere (FR)

(72) Inventors: Nathalie LALOI, La Verriere (FR); Guillaume BARRET, La Verriere (FR); Alexis BRAUN, La Verriere (FR); Jerome JEANPIERRE, La Verriere (FR)

(73) Assignee: VALEO SYSTEMES D'ESSUYAGE, La Verriere (FR)

(21) Appl. No.: 18/998,177

(22) PCT Filed: Jun. 26, 2023
(86) PCT No.: PCT/EP2023/067245

§ 371 Date: Jan. 24, 2025

(30) Foreign Application Priority Data
Jul. 26, 2022 (FR) 2207682

(51) Int. Cl. B60S 1/40

(52) U.S. Cl. CPC B60S 1/4038; B60S 2001/4096

(57) ABSTRACT

The invention relates to a windshield wiper connector (12) comprising means (19) for articulation to a wiper arm, an interface (26) for attaching a wiper member, a reinforcing element (18) for stiffening the interface (26) for attaching the wiper member, the reinforcing element (18) comprising pairs of claws (20) for attaching the wiper member and comprising a connecting portion (22) extending between the pairs of claws. The invention also relates to a windshield wiper having the connector as well as to a vehicle having the windshield wiper. The invention also relates to a process for manufacturing a connector.

The invention makes it possible to support a longer wiper blade without the blade becoming detached during operation of the windshield wiper.

### TECHNICAL FIELD

The invention relates to a windshield-wiper connector, to a windshield wiper with the connector and to a vehicle with the windshield wiper. The invention also relates to a method for manufacturing a connector.

### BACKGROUND OF THE INVENTION

Windshield-wiper blade frames are becoming increasingly long in order to wipe a larger surface area of a window of a vehicle, in particular, the windshield at the front of the vehicle. As the length of the blade frames increases, the lateral loading to be withstood, transversely to the length of the blade frames, by a connector connecting the blade frame to the arm also increases. There is thus a risk of the blade frame becoming detached from the connector and/or of the connector breaking under the lateral loading exerted at any point along the length of the blade frame during operation.

### SUMMARY OF THE INVENTION

There is therefore a need for a connector for a windshield-wiper blade frame that can support a blade frame of greater length without the blade frame becoming detached from the connector and/or the connector breaking under the lateral loading exerted at any point along the length of the blade frame during operation.

The aim of the invention is to provide a connector for a windshield-wiper blade frame that can support a blade frame of greater length without the blade frame becoming detached from the connector and/or the connector breaking under the lateral loading exerted at any point along the length of the blade frame during operation.

To this end, the invention proposes a connector for a windshield-wiper blade frame, comprising means for connecting to a windshield-wiper arm in an articulated manner, an interface for securing a windshield-wiper vertebra, a reinforcement for stiffening the interface for securing the vertebra, the reinforcement having pairs of claws for securing the vertebra and having a connecting portion extending between the pairs of claws.

According to one variant, the reinforcement is made of metal,

According to one variant, the connector extends in a longitudinal direction, the pairs of claws of the reinforcement being situated at two ends of the connector, in the longitudinal direction.

According to one variant, the reinforcement is circumscribed by the interface for securing the vertebra.

According to one variant, the interface for securing the vertebra has two pairs of claws for securing the vertebra, the claws of the reinforcement being surrounded by the claws of the interface for securing the vertebra.

According to one variant, the connector further comprises a clearance for the passage of a wiper blade, the connecting portion being situated along the clearance for passage of the wiper blade.

According to one variant, the interface for securing the vertebra is circumscribed by the reinforcement.

According to one variant, the interface for securing the vertebra has two pairs of claws for securing the vertebra, the claws of the interface for securing the vertebra being surrounded by the claws of the reinforcement.

According to one variant, the reinforcement is embedded in the interface for securing the vertebra.

The invention also relates to a windshield-wiper blade frame comprising the connector as described above, to a vertebra secured to the interface for securing a vertebra, and to a wiper blade.

The invention also relates to a vehicle with a windshield-wiper blade frame as described above.

The invention also relates to a method for manufacturing a connector for a windshield-wiper blade frame as described above, wherein the reinforcement is secured to the interface for securing the vertebra by a step of overmolding or clip-fastening the reinforcement into the interface for securing the vertebra.

The invention also relates to a method for manufacturing a connector for a windshield-wiper blade frame as described above, wherein the reinforcement is secured to the interface for securing the vertebra by a step of clip-fastening the reinforcement around the interface for securing the vertebra.

All of the preferred embodiments and all of the advantages of the connector according to the invention may be transferred, mutatis mutandis, to the present windshield-wiper blade frame and to the vehicle, and vice versa. The different embodiments may be taken in combination or considered in isolation.

### BRIEF DESCRIPTION OF DRAWINGS

Further features and advantages of the present invention will become apparent from reading the following detailed description, for the understanding of which reference will be made to the appended figures, in which:

FIG. 1 shows a schematic view of one exemplary embodiment of a connector;

FIG. 2 shows another view of the connector from FIG. 1; and

FIG. 3 shows a schematic view of another exemplary embodiment of a connector.

The drawings in the figures are not to scale. Similar elements are generally denoted by similar references in the figures. In the context of this document, identical or similar elements may bear the same references. Furthermore, the presence of reference numbers or letters in the drawings cannot be considered limiting, including when these numbers or letters are indicated in the claims.

### DETAILED DESCRIPTION OF THE INVENTION

The invention proposes a windshield-wiper connector, comprising means for connecting to a windshield-wiper arm in an articulated manner, an interface for securing a windshield-wiper vertebra and a reinforcement for stiffening the interface for securing the vertebra. The reinforcement has pairs of claws for securing the vertebra and has a connecting portion extending between the pairs of claws. The connector makes it possible to support a blade frame of greater length without the blade frame becoming detached from the connector and/or the connector breaking under the lateral loading exerted at any point along the length of the blade frame during operation. Furthermore, the bulk of the connector is limited.

The figures show a connector 12 for a windshield wiper 10. The windshield wiper 10 has a blade frame 14 having a vertebra 16 supporting a blade 17. The blade frame 14 extends in a longitudinal Y direction. The blade frame 14 may have an elongate shape. The blade frame 14 may have a longitudinal shape. The same applies to the vertebra 16 and the blade 17 extending in the longitudinal Y direction. The blade 17 is able to rest against the window of a vehicle, for example the windshield, and to ensure wiping thereof by way of back-and-forth movements of the windshield wiper 10. The blade 17 extends through the vertebra 16 toward the window, projecting from that face of the vertebra 16 that is not shown in the figures.

The blade frame 14 is able to exert a pressure in accordance with a defined pattern on the window to be wiped in the longitudinal direction. The pressure on the window is variable along the longitudinal shape of the blade frame 14, the pressure being greater at the center of the blade frame in order to compensate for aerodynamic lift. To this end, the vertebra 16 has a curved shaped when it is not pressed against the window; when it is pressed against the window, the pressure imparted on the window is variable along the longitudinal shape of the blade frame 14. The vertebra 16 confers stiffness on the blade frame 14 over the entire length. thereof. In particular, the vertebra 16 enables the blade 17 to be held and ensures the stiffness thereof over the entire length thereof.

The material of the blade 17 is more flexible than that of the vertebra 16, in order to ensure wiping of the window; the material of the vertebra 16 is stiffer than that of the blade 17, so as to ensure the stiffness of the blade 17 over the entire length thereof. The vertebra 16 is made of metal, for example. In addition, the vertebra 16 may consist of a single piece (which holds the blade in a central slot) or of a plurality of pieces (which clamp the blade between them). Throughout the description, the term “vertebra” will be used non-limitingly in the singular.

The blade frame 14 may also have a cowling covering the vertebra 16, on that face of the vertebra 16 that is shown in the figures. The cowling itself is not shown in the figures.

The windshield wiper 10 moreover has an arm (not shown in the figures) driven in movement at one of its ends by drive means and driving the blade frame 14 in movement at its other end. The arm is connected to the blade frame 14 via the connector 12. The connector 12 may be secured to the arm by articulation means, such as pivots 19, which are shown in the figures.

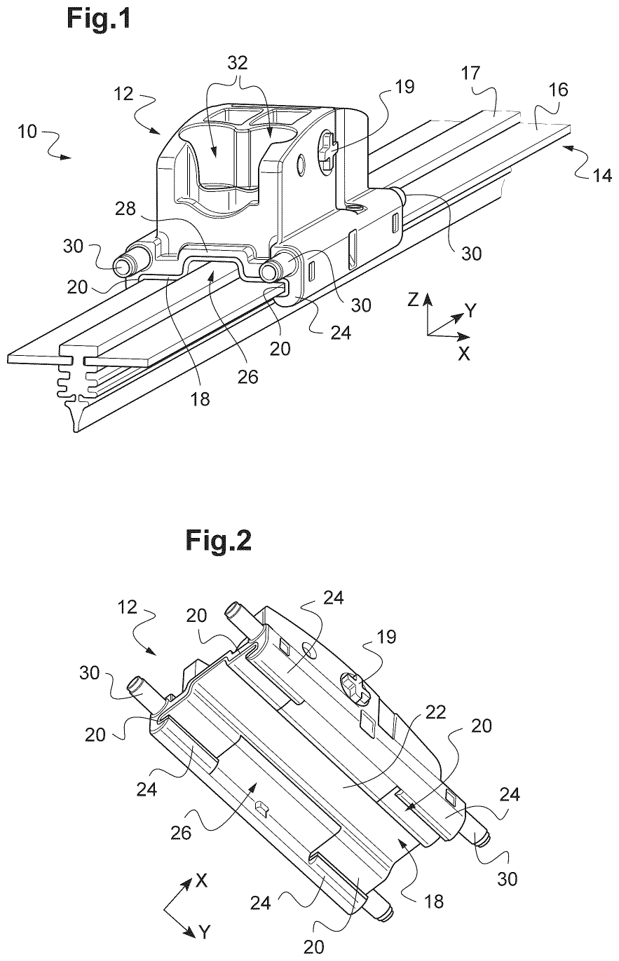

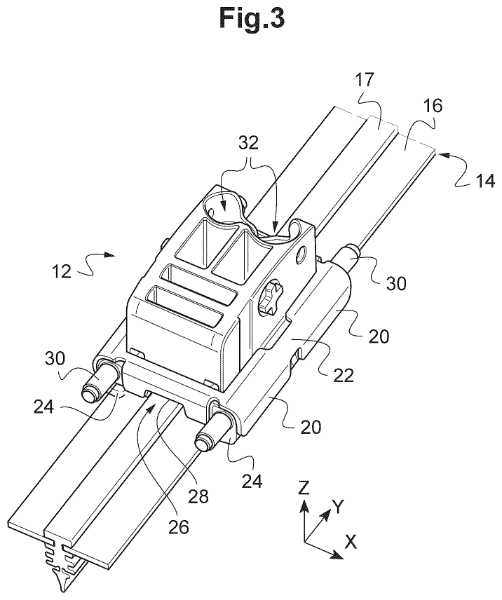

The connector 12 extends in the longitudinal Y direction and has an interface 26 for securing the vertebra 16 in the longitudinal Y direction. The interface 26 is shown in FIGS. 1 and 3, but also in FIG. 2, which shows another view of the connector from FIG. 1 (from below). The blade frame 14 is thus held on the connector 12 in the longitudinal direction via the securing interface 26.

In order to reinforce the securing interface 26, the connector comprises a reinforcement 18 for stiffening the interface 26. The reinforcement 18 has claws 20 for securing the vertebra 16. This makes it possible to fixedly secure the vertebra 16 to the connector 12. The claws 20 are arranged in pairs, thereby making it possible to secure the vertebra 16 on two opposing edges at each pair. The pairs of claws 20 make it possible to clamp the vertebra 16 in order to better secure it. The pairs of claws make it possible to avoid the vertebra 16 being ejected from the securing interface 26 when the blade frame is subjected to lateral loading forces during operation of the windshield wiper. The lateral loading is even greater—and the risk of the vertebra 16 being ejected is increased—when the blade frame has a length of greater than 800 mm, for example between 800 and 1300 mm. The claws 20 of one pair may face one another in the X direction, which is transverse to the longitudinal Y direction of the vertebra 16; the claws 20 may also be offset in the X direction. A plurality of pairs of claws 20 are provided in order to grip the vertebra 16 at various locations along the securing interface 26. In the figures, two pairs of claws 20 are provided by way of example. Since the connector 12 extends in the longitudinal Y direction, the pairs of claws 20 of the reinforcement are at the two ends of the connector 12, in the longitudinal direction. The pairs of claws 20 are thus furthest away from one another within the connector, in order to reduce the rotation of the vertebra 16 about the Z axis.

The stiffening reinforcement 18 also has a connecting portion 22 extending between the pairs of claws 20. The connecting portion 22 provides a connection between the pairs of claws 20. The connecting portion 22 further increases the stiffness conferred by the reinforcement 18. In particular, the connecting portion 22 prevents the connector 12 from breaking open between its two ends. Specifically, and as mentioned above, the lateral loading exerted on the blade frame is high when the windshield wiper is in use, and is even greater when the blade frame is elongate. The lateral loading on the blade frame during operation leads to torsional stress on the connector 12, which withstands this by virtue of the reinforcement 18 and in particular the connecting portion 22.

Furthermore, by virtue of the reinforcement 18, the connector makes it possible to reduce the risk of the securing interface 26 opening and therefore the risk of the vertebra being ejected. It is thus possible to increase the lateral loading applied to the blade frame 14 by way of an increase in the size thereof, without thereby increasing the size of the connector 12. Limiting the size of the connector 12 prevents the vertebra from being flattened (deformation of the curved shape thereof) and prevents the distribution of the pressure on the window from being undermined. Moreover, the reinforcement 18 makes it possible to strengthen the connector 12 while at the same time avoiding an increase in the volume of material required to manufacture it. This also avoids an increase in the bulk of the connector.

The connector 12 is made of a material that can withstand high stresses and can be subjected to high temperatures. Preferably, the material of the connector 12 is lightweight. The material of the connector 12 is glass-fiber-reinforced plastic, for example. The material is glass-fiber-reinforced polyamide, for example. The reinforcement 18 is made of a material that is stiffer and stronger than that of the connector 12. For example, the reinforcement 18 is made of metal. Combining the metal reinforcement with the plastic connector 12 has the advantage of yielding an assembly that is both lightweight and highly stiff.

Preferably, the interface 26 for securing the connector also has claws 24 for securing the vertebra 16—which are distributed in pairs along the securing interface. The claws 24 of the interface 26 and the claws 20 of the reinforcement are at the same level along the connector. Thus, the claws 24 of the interface 26 are reinforced by the claws 20 of the reinforcement 18. More particularly, the vertebra 16 is held on the connector 12 solely at the claws 20, 24. In other words, the vertebra 16 is secured to the connector at certain points by the claws 20, 24. Thus, the vertebra 16 is held on the connector solely at the claws 20, 24 so as not to flatten the vertebra and therefore not to disrupt the distribution of the pressure of the blade frame 14 on the window.

The connector 12 may also comprise a clearance region 28 within the securing interface 26. This is a longitudinal cavity, along the interface 26, that allows the blade 17 to pass along the connector 12. This prevents the blade frame 14 from being stressed by the connector 12, over the entire length of the connector 12 between the ends thereof, which could flatten the vertebra 16 and disrupt the distribution of the pressure of the blade frame 14 on the window.

FIGS. 1 and 2 show one exemplary embodiment of the connector and FIG. 3 shows another exemplary embodiment of the connector 12.

In FIGS. 1 and 2, the reinforcement 18 is circumscribed by the interface 26 for securing the vertebra 16. The reinforcement 18 is surrounded by the securing interface 26. The reinforcement 18 is situated between the vertebra 16 and the interface 26. The reinforcement 18 is in contact with the vertebra 16. The reinforcement 18 is situated in the interface 26. This embodiment has the advantage of making it easier to assemble the reinforcement 18 on the connector 12.

As is shown in FIG. 2, the interface 26 for securing the vertebra has two pairs of claws 24 for securing the vertebra, the claws 20 of the reinforcement 18 being surrounded by the claws 24 of the interface 26 for securing the vertebra 16. Thus, it is the claws 20 of the reinforcement that absorb the lateral loading forces of the vertebra,

In the embodiment in FIGS. 1 and 2, the connecting portion 22 between the claws 20 of the reinforcement is situated along the clearance 28 for the passage of the blade 17. This makes it possible to not impede the passage of the blade frame 14 along the connector 12 and to maintain the above-mentioned advantages with regard to the clearance 28.

In FIG. 3, according to another embodiment of the reinforcement 18, the interface 26 for securing the vertebra 16 is circumscribed by the reinforcement 18. The securing interface 26 is surrounded by the reinforcement 18. The interface 26 is situated between the vertebra 16 and the reinforcement 18. The interface 26 is in contact with the vertebra 16. The reinforcement 18 is situated outside the interface 26. This embodiment has the advantage of making it easier to dimension the connector 12.

According to this embodiment, the interface 26 for securing the vertebra has two pairs of claws 24 for securing the vertebra, the claws 24 of the interface 26 for securing the vertebra 16 being surrounded by the claws 20 of the reinforcement 18. Thus, the claws 20 of the reinforcement reinforce the claws 24 of the interface 26 when the vertebra is subject to lateral loading forces. Moreover, the connecting portion 22 of the reinforcement is situated between the claws 20, outside the interface 26.

According to yet another embodiment, which is not depicted in the figures, the reinforcement 18 is embedded in the interface 26 for securing the vertebra 16. This further simplifies the manufacturing of the connector. In addition, this protects the reinforcement against moisture and impacts against other elements of the vehicle.

The embodiments differ in terms of the placement of the reinforcement 18, but the other features described apply to the various embodiments.

The connector also has nozzles 30 for discharging water in the longitudinal Y direction. The nozzles 30 allow water to be discharged along the blade frame 14, and more specifically along the vertebra 16. The nozzles 30 are connected to ducts extending in the cowling in the longitudinal direction of the blade frame 14. The cowling and/or the connector may be provided with orifices for discharging water along the longitudinal direction. This makes it possible to discharge cleaning water onto the window, as close as possible to the blade 17, over the entire length of the blade 17. The nozzles 30 are supplied by water inlets 32. In the figures, the connector 12 has two pairs of nozzles 30 respectively supplied by a water inlet 32; each pair of nozzles 30 allows water to be discharged along a respective edge of the vertebra 16. The reinforcement 18 enables the connector to better withstand the lateral loading imposed on the blade frame without thereby increasing the amount of material needed to form the claws 24 of the interface 26; this avoids disturbing the circulation of water within the connector from the water inlets 32 to the nozzles 30.

The invention also relates to a windshield-wiper blade frame 10 comprising the connector 12 to which a vertebra 16 is secured by way of the securing interface 26, and to a wiper blade 17. By virtue of the reinforcement 18, the connector makes it possible to reduce the risk of the securing interface 26 opening and therefore the risk of the vertebra being ejected. It is thus possible to increase the lateral loading applied to the blade frame 14 by way of an increase in the size of the blade frame, without thereby increasing the size of the connector 12. Limiting the size of the connector 12 prevents the vertebra from being flattened and prevents the distribution of the pressure on the window from being undermined. The reinforcement 18 also makes it possible to avoid increasing the amount of material required to manufacture the connector.

The invention also relates to a vehicle with the windshield-wiper blade frame described. The blade frame 14 may be elongate, with a length of between 800 and 1300 mm, thereby making it possible to wipe a larger surface area of a window. Furthermore, this increases the size of the blade frame while at the same time limiting the bulk of the connector. Limiting the bulk of the connector prevents the latter from colliding with the surroundings of the connector—in particular the window of the vehicle.

The invention also relates to methods for manufacturing the connector 12 for a windshield-wiper blade frame. According to the embodiment in FIGS. 1 and 2, the reinforcement 18 is secured to the interface 26 for securing the vertebra by a step of overmolding the reinforcement 18 into the interface 26 for securing the vertebra. The connector 12 is obtained by molding the material around the reinforcement 18. This method is also applicable when the reinforcement 18 is embedded in the securing interface 26. The connector 18 is thus already provided with the reinforcement 18 when it is removed from the mold. Alternatively, the reinforcement is secured to the interface for securing the vertebra by a step of clip-fastening the reinforcement into the interface for securing the vertebra. This makes it easier to manufacture the connector. According to the embodiment in FIG. 3, the reinforcement 18 is secured to the interface 26 for securing the vertebra by a step of clip-fastening the reinforcement 18 around the interface for securing the vertebra. This manufacturing method is simple to carry out.

The present invention has been described in relation to specific embodiments, which have purely illustrative value and should not be considered limiting. In general, it will be obvious to a person skilled in the art that the present invention is not limited to the examples illustrated and/or described above. For example, the connector described may be used with elongate blade frames that are, for example, more than 1000 mm long, but also with blade frames that are less than 1000 mm long. In addition, the connector 12 may be used in a windshield wiper for a rear window of a vehicle.

What is claimed is:

1. A connector for a windshield-wiper blade frame, comprising:
means for connecting to a windshield-wiper arm in an articulated manner,
an interface for securing a windshield-wiper vertebra, and
a reinforcement or stiffening the interface for securing the vertebra, the reinforcement having pairs of claws for securing the vertebra and having a connecting portion extending between the pairs of claws.

2. The connector as claimed in claim 1, wherein the reinforcement is made of metal.

3. The connector as claimed in claim 1, the connector extending in a longitudinal direction, the pairs of claws of the reinforcement being situated at two ends of the connector, in the longitudinal direction.

4. The connector as claimed in claim 1, wherein the reinforcement is circumscribed by the interface for securing the vertebra.

5. The connector claimed in claim 4, wherein the interface for securing the vertebra has two pairs of claws for securing the vertebra, the claws of the reinforcement being surrounded by the claws of the interface for securing the vertebra.

6. The connector as claimed in claim 1, further comprising a clearance for the passage of a wiper blade, the connecting portion being situated along the clearance for passage of the wiper blade.

7. The connector as claimed in claim 1 wherein the interface for securing the vertebra is circumscribed by the reinforcement.

8. The connector as claimed in claim 7, wherein the interface for securing the vertebra has two pairs of claws for securing the vertebra, the claws of the interface for securing the vertebra being surrounded by the claws of the reinforcement.

9. The connector as claimed in claim 1, wherein the reinforcement is embedded in the interface for securing the vertebra.

10. A windshield-wiper blade frame comprising.
a connector including a means for connecting to a windshield-wiper arm in an articulated manner an interface for securing a vertebra, and a reinforcement or stiffening the interface for securing the vertebra, the reinforcement having pairs of claws for securing the vertebra and having a connecting portion extending between the pairs of claws,
the vertebra secured to the interface for securing a vertebra, and
a wiper blade.

11. A vehicle with a windshield wiper blade frame comprising a connector including a means for connecting to a windshield-wiper arm in an articulated manner, an interface for securing a vertebra, and a reinforcement or stiffening the interface for securing the vertebra, the reinforcement having pairs of claws for securing the vertebra and having a connecting portion extending between the pairs of claws, the vertebra secured to the interface for securing a vertebra, and a wiper blade.

12. (canceled)

13. (canceled)

14. The connector as claimed in claim 4, wherein the reinforcement is secured to the interface for securing the vertebra with overmolding.

15. The connector as claimed in claim 4, wherein the reinforcement is secured to the interface for securing the vertebra by clip-fastening the reinforcement into the interface for securing the vertebra.

16. The connector as claimed in claim 7, wherein the reinforcement is secured to the interface for securing the vertebra by clip-fastening the reinforcement around the interface for securing the vertebra.
